(19) United States
(12) Patent Application Publication
(10) Pub. No.: US 2012/0249625 A1
(43) Pub. Date: Oct. 4, 2012

(54) CONTROL DEVICE, INFORMATION PROCESSING DEVICE, AND METHOD OF CONTROLLING A CONTROL DEVICE

(75) Inventor: Kenji Asada, Matsumoto-shi (JP)

(73) Assignee: Seiko Epson Corporation, Shinjuku-ku (JP)

(21) Appl. No.: 13/430,513

(22) Filed: Mar. 26, 2012

(30) Foreign Application Priority Data
Mar. 30, 2011 (JP) 2011-074398

(51) Int. Cl. H04N 1/034

(52) U.S. Cl. 347/3

(57) ABSTRACT

What ink cartridge is best suited to a recording device can be determined. A management server includes a related information acquisition unit that gets related information, which is information related to recording using an ink cartridge in a coupon printer, from a central server; and a model information output unit that based on the acquired related information outputs model information including information identifying the model of ink cartridge suited to use by the coupon printer.

Priority is claimed under 35 U.S.C. §119 to Japanese Application No. 2011-074398 filed on Mar. 30, 2011, which is hereby incorporated by reference in its entirety.

### BACKGROUND

1. Technical Field

The present invention relates to a control device capable of communicating with a recording device in which an ink cartridge is loaded, to an information processing device capable of connecting to the recording device, and to a method of controlling the control device.

2. Related Art

Systems having a recording device (printer) for recording using an ink cartridge are known from the literature. See, for example, Japanese Unexamined Patent Appl. Pub. JP-A-2002-36582. Users of such systems may also be serviced by the printer manufacturer or another company that makes and sells ink cartridges supplying the user of the recording device with ink cartridges when needed.

In addition to common ink cartridges, the ink cartridge manufacturer may also provide various models of ink cartridges for different needs, including high capacity ink cartridges that store more ink for high frequency users of the recording system.

How a recording device is used differs for each recording device according to the environment in which the recording device is installed, for example. For a manufacturer or supplier to supply the user with ink cartridges, the supplier must therefore know what ink cartridges are suitable for the recording device being serviced (in which the ink cartridges will be used).

### SUMMARY

The invention enables determining what ink cartridge is suited to a particular recording device.

One aspect of the invention is a control device that is communicatively connected to an information processing device that can connect to a recording device in which an ink cartridge is installed and which records by ejecting ink from a recording head, the control device including: a related information acquisition unit that acquires related information, which is information related to recording by the recording device using the ink cartridge, from the information processing device; and a model information output unit that, based on a history of the related information acquired by the related information acquisition unit, determines at least a model of the ink cartridge suited to use by the recording device selected from among a plurality of ink cartridge models, and outputs model information including information identifying the ink cartridge model.

In this aspect of the invention the output model information includes information identifying the ink cartridge that is best suited to the recording device in the group of plural ink cartridge models that can be used in the recording device based on information related to recording using an ink cartridge in the recording device. This model information can therefore be used to determine the ink cartridge appropriate for the recording device.

In a control device according to another aspect of the invention, the related information includes at least information related to the type of operation related to recording in the recording device; and the model information output unit determines the model of ink cartridge suited to the recording operation performed by the recording device selected from among plural ink cartridge models based on a history of information related to the type of operation related to recording in the recording device acquired by the related information acquisition unit, and outputs the model information including information identifying the model of ink cartridge.

Because the output model information includes information identifying the ink cartridge suited to the type of operations related to recording that are performed in the recording device, this model information can be used to determine the ink cartridge suited to the recording device based on the type of operations related to recording that are performed in the recording device.

In a control device according to another aspect of the invention, the information related to the type of operation related to recording in the recording device is information related to consumption of ink in the ink cartridge, or information related to the frequency of recording operations in the recording device.

The model information output in this aspect of the invention includes information identifying the type of ink cartridge suited to the type of operation related to recording in the recording device based on information related to consumption of ink in the ink cartridge, or information related to the frequency of recording operations in the recording device, and this model information can therefore be used to determine the ink cartridge appropriate to the recording device to reflect the types of recording-related operations performed in the recording device.

In a control device according to another aspect of the invention, the related information includes at least information related to ejection of ink from the ink cartridge; and the model information output unit determines the model of ink cartridge suited to the ink ejection conditions selected from among plural ink cartridge models based on a history of information related to ink ejection from the ink cartridge acquired by the related information acquisition unit, and outputs the model information including information identifying the model of ink cartridge.

The model information output in this aspect of the invention includes information indicating the model of ink cartridge suited to the ink ejection conditions selected from among plural ink cartridge models, and this model information can be used to determine the ink cartridge suited to the recording device based on the ink ejection conditions.

In a control device according to another aspect of the invention, one model of ink cartridge stores ink including ink that is ejected from the recording head for an application other than recording; the information related to ink ejection from the ink cartridge includes information related to an error associated with inspecting ink ejection by the recording head; and the model information output unit outputs the model information including information identifying the one model of ink cartridge as the ink cartridge model suited to the recording device based on a history of information related to an error associated with inspecting ink ejection by the recording head acquired by the related information acquisition unit.

When one model of ink cartridge is used to resolve ink ejection problems, this aspect of the invention can use the model information to appropriately provide the one model of ink cartridge.

In a control device according to another aspect of the invention, the information related to an error associated with inspecting ink ejection by the recording head includes information identifying a result of a recording head nozzle check, or information related to a nozzle ejection problem.

Because the model information that is output in this aspect of the invention includes information identifying the result of a nozzle check of the recording head of the recording device, or information identifying the ink cartridge appropriate to the ink ejection conditions reflecting the information related to nozzle ejection problems, this model information can be used to determine the ink cartridge appropriate to the recording device based on the actual ink ejection state of the recording device.

Another aspect of the invention is an information processing device that can connect to a recording device in which an ink cartridge is installed and which records by ejecting ink from a recording head, the information processing device including: a related information acquisition unit that acquires related information, which is information related to recording by the recording device using the ink cartridge, from the recording device; and a model information output unit that, based on a history of the related information acquired by the related information acquisition unit, determines at least a model of the ink cartridge suited to use by the recording device selected from among a plurality of ink cartridge models, and outputs model information including information identifying the ink cartridge model.

In this aspect of the invention the output model information includes information identifying the ink cartridge that is best suited to the recording device in the group of plural ink cartridge models that can be used in the recording device based on information related to recording using an ink cartridge in the recording device. The information processing device can therefore use this model information to determine the ink cartridge appropriate for the recording device.

Another aspect of the invention is a control system including an information processing device that can connect to a recording device in which an ink cartridge is installed and which records by ejecting ink from a recording head, and a control device capable of communicating with the information processing device, wherein the control device has: a related information acquisition unit that acquires related information, which is information related to recording by the recording device using the ink cartridge, from the information processing device; and a model information output unit that, based on a history of the related information acquired by the related information acquisition unit, determines at least a model of the ink cartridge suited to use by the recording device selected from among a plurality of ink cartridge models, and outputs model information, which is information including information identifying the ink cartridge model.

In this aspect of the invention the output model information includes information identifying the ink cartridge that is best suited to the recording device in the group of plural ink cartridge models that can be used in the recording device based on information related to recording using an ink cartridge in the recording device. This model information can therefore be used to determine the ink cartridge appropriate for the recording device.

Another aspect of the invention is a control method for a control device that is communicatively connected to an information processing device that can connect to a recording device in which an ink cartridge is installed and which records by ejecting ink from a recording head, the control method including steps of: acquiring related information, which is information related to recording by the recording device using the ink cartridge, from the information processing device; and determining at least a model of the ink cartridge suited to use by the recording device selected from among a plurality of ink cartridge models based on a history of acquired related information; and outputting model information, which is information including information identifying the ink cartridge model.

With the control method according to this aspect of the invention, the output model information includes information identifying the ink cartridge that is best suited to the recording device in the group of plural ink cartridge models that can be used in the recording device based on information related to recording using an ink cartridge in the recording device. This model information can therefore be used to determine the ink cartridge appropriate for the recording device.

Another aspect of the invention is a program that is executed by a control unit that controls a control device that is communicatively connected to an information processing device that can connect to a recording device in which an ink cartridge is installed and which records by ejecting ink from a recording head, the program causing the control unit to function as: a related information acquisition unit that acquires related information, which is information related to recording by the recording device using the ink cartridge, from the information processing device; and a model information output unit that, based on a history of the related information acquired by the related information acquisition unit, determines at least a model of the ink cartridge suited to use by the recording device selected from among a plurality of ink cartridge models, and outputs model information, which is information including information identifying the ink cartridge model.

By executing this program, the output model information includes information identifying the ink cartridge that is best suited to the recording device in the group of plural ink cartridge models that can be used in the recording device based on information related to recording using an ink cartridge in the recording device. This model information can therefore be used to determine the ink cartridge appropriate for the recording device.

### EFFECT OF THE INVENTION

The invention enables determining what ink cartridge is appropriate for a recording device.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a control system.

FIG. 2 is a block diagram of a coupon printer and a coupon printer control computer.

FIG. 3 is a block diagram showing the functional configuration of a central server.

FIG. 4 shows the data structure of a related information database.

FIG. 5 shows the functional configuration of a control server.

FIG. 6 is a flow chart of management server operation.

FIG. 7 is a flow chart of management server operation.

FIG. 8 is a flow chart of management server operation.

FIG. 9 shows an example of related information.

### DESCRIPTION OF EMBODIMENTS

A preferred embodiment of the present invention is described below with reference to the accompanying figures.

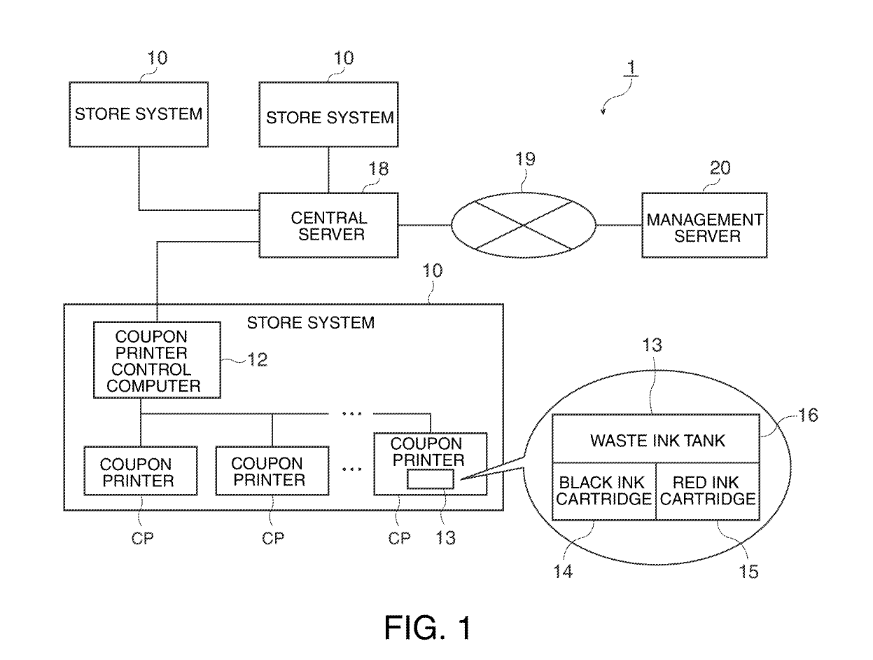

FIG. 1 is a block diagram showing the configuration of a control system 1 according to this embodiment of the invention.

As shown in FIG. 1, the control system 1 has a store system 10.

The store system 10 is a system that is deployed in a store such as a supermarket or convenience store, and has at least a function for issuing coupons to customers of the store.

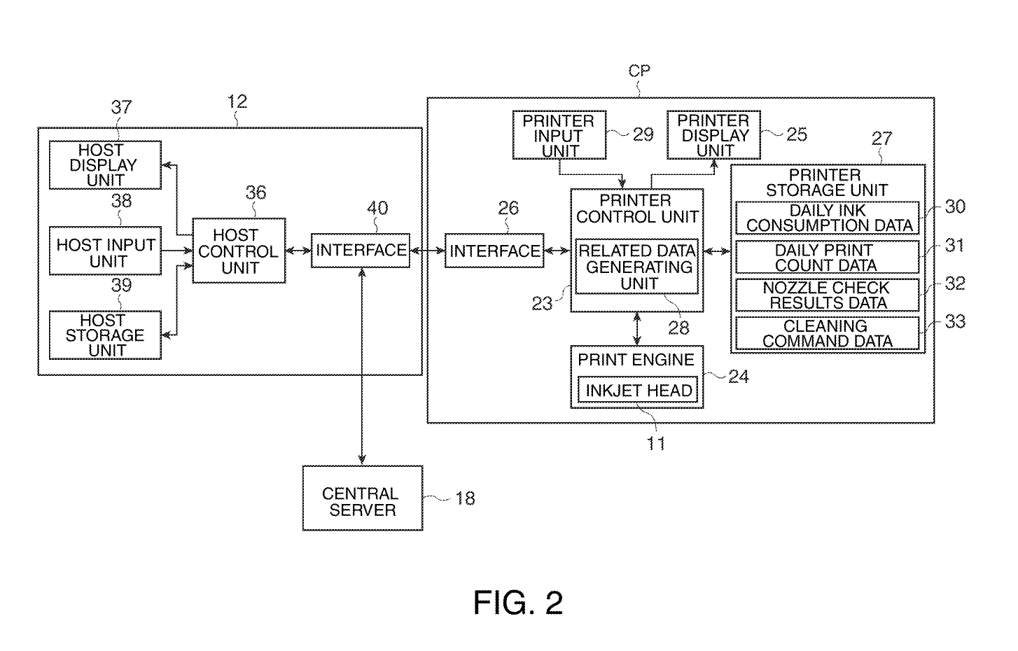

The store system 10 has a plurality of coupon printers CP for printing coupons. A coupon printer control computer 12 that controls the printers is connected to each of the coupon printers CP. Each coupon printer CP in this embodiment has an inkjet head 11 (FIG. 2) capable of ejecting two colors of ink, black and red in this example. The coupon printers CP are inkjet printers that eject ink from the inkjet head 11 (recording head) onto a recording medium while scanning the recording medium in the primary scanning direction to record two-color images of black and red on the recording medium as controlled by the coupon printer control computer 12.

The coupon printer CP uses ink from a loaded ink cartridge 13 to perform a process that records images.

The ink cartridge 13 in this embodiment of the invention is a cartridge that combines a black ink cartridge 14 storing black ink, a red ink cartridge 15 that stores red ink, and a waste ink tank 16 for collecting waste ink, in a single cartridge unit. If the amount of black ink remaining in the black ink cartridge 14 drops below a specific level, the amount of red ink remaining in the red ink cartridge 15 drops below a specific level, or the amount of waste ink accumulated in the waste ink tank 16 exceeds a specific level, the ink cartridge 13 is removed from the coupon printer CP and a new ink cartridge 13 is installed.

A coupon printer CP is installed at a plurality of cash registers in the store, and print specific coupons at specific times as controlled by the coupon printer control computer 12.

As shown in FIG. 1, the store system 10 in this control system 1 is connected to a central server 18 (information processing device). More specifically, the coupon printer control computer 12 of the store system 10 is communicatively connected to a central server 18.

The central server 18 stores information related to the coupons that are issued and other information, including information related to store system 10 maintenance, and the coupon printer control computer 12 can get the necessary information by accessing the central server 18 as needed.

The central server 18 and coupon printer control computer 12 work together to perform the database generating process described below.

The central server 18 and store system 10 are managed by an entity that runs the store. This entity that runs the store also installs the central server 18 in the corporate headquarters, for example, when constructing the store system 10, and manages the store system 10 through the central server 18. For convenience below, the entity that runs the store is referred to as the user U.

The central server 18 is connected to a management server 20 (control device) through a network 19 such as the Internet. The central server 18 and management server 20 communicate securely by means of communication using a specific encryption protocol, communication over a virtual private network, or communication over a dedicated physical line.

The management server 20 is a server that is managed by the manufacturer M, which is an entity that manufactures and sells the ink cartridges 13.

In this embodiment of the invention the manufacturer M provides a service of supplying the store with ink cartridges 13. Supplying a store with ink cartridges 13 as used herein refers to supplying the store with new ink cartridges 13 by shipping the ink cartridges 13 from the manufacturer M to the store, by a manufacturer M sales representative delivering ink cartridges 13 directly to the store in person, or supplying the ink cartridges through a third-party systems integrator, for example. The ink cartridges 13 are supplied to the store when requested by the store or at regularly scheduled times, for example.

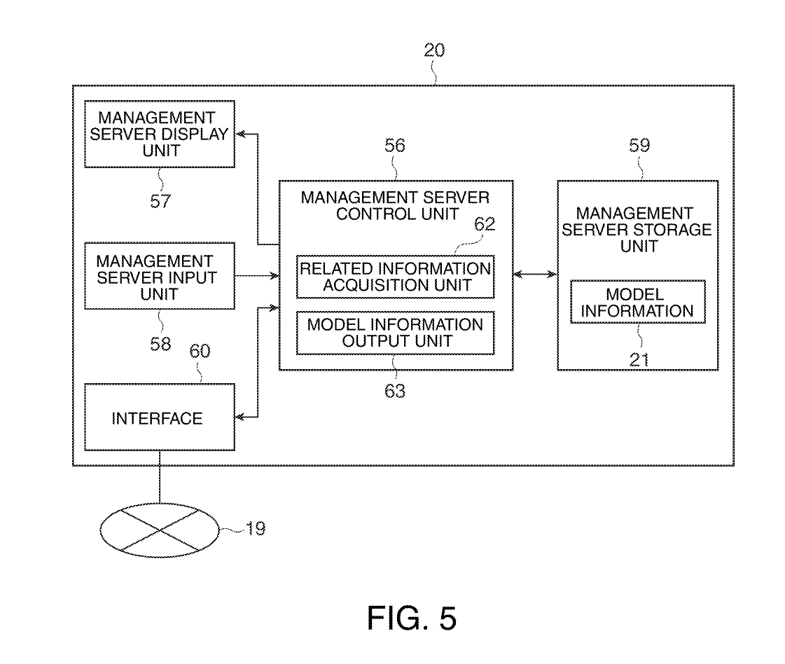

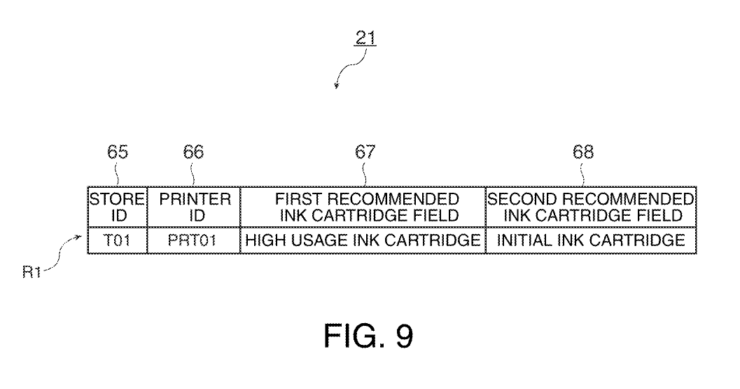

The management server 20 has a function that outputs model information 21 (FIG. 5, FIG. 9) including information describing the model of ink cartridge 13 to be supplied to the user U as further described below.

FIG. 2 is a block diagram showing the functional configuration of the coupon printer CP and the coupon printer control computer 12 that controls the coupon printer CP.

The coupon printer CP is an inkjet printer, and is capable of performing at least a cleaning operation, flushing operation, high-intensity flushing operation, and a nozzle check operation.

The cleaning operation is an operation that forcibly suctions ink accumulated in the nozzles in order to prevent the viscosity of ink that is left inside the nozzles (not shown in the figure) of the inkjet head 11 (FIG. 2) from increasing over time in order to prevent ink ejection problems caused by viscous ink.

The coupon printer CP has a mechanism that applies negative pressure to the nozzles of the inkjet head 11 to suction ink from inside the nozzles, and performs the flushing operation using this mechanism.

This cleaning operation may be performed automatically by the printer control unit 23, or when triggered by the user U (such as an operator in the store) issuing a cleaning command. When the cleaning operation is performed by a user command, an ink ejection problem has occurred or something suggesting an ejection problem has happened, and the cleaning operation is performed to solve the problem.

The flushing operation is an operation that ejects ink from the nozzles to replace the ink left in the nozzles with fresh ink when ink is not normally ejected onto the recording medium.

In an inkjet head 11 with numerous nozzles, ink left in the nozzles can dry and increase in viscosity over time, leading to ink ejection problems.

The flushing operation is an operation performed to prevent such ink ejection problems by discharging a specific amount of ink from the nozzles of the inkjet head 11 to replace the ink left in the nozzles with fresh ink.

The flushing operation is performed automatically after moving the inkjet head 11 to the home position HP after the passage of a specific time while recording is in progress, or when other specific conditions are met.

The nozzle check operation is an operation that checks the ink ejection state of each nozzle of the inkjet head 11.

This nozzle check operation may be performed as follows.

First, the inkjet head 11 is moved to a specific position. An electrical conductor is disposed in the area to which ink is ejected from the inkjet head 11 when at this specific position, and current flowing through this conductor can be detected.

The printer control unit 23 causes one nozzle of the inkjet head 11 to eject charged ink droplets to where the conductor is disposed, detects the current flowing through the conductor, and determines if there is an ink ejection problem with that one nozzle by determining based on the state of the detected current if the expected amount of ink was ejected as expected.

Alternatively, ink could be ejected from one nozzle onto the recording medium for a nozzle check and the dot formed on the recording medium optically read to determine if there is an ejection problem with that one nozzle.

The nozzle check is performed when instructed by the user U or timed appropriately after the above cleaning operation or flushing operation is performed.

The ink discharged from the nozzles by the cleaning operation, flushing operation, or nozzle check operation is collected as waste ink through a specific mechanism in the waste ink tank 16 of the ink cartridge 13.

As shown in FIG. 2, the coupon printer CP includes a printer control unit 23, print engine 24, printer display unit 25, printer input unit 29, printer interface 26, and printer storage unit 27.

The printer control unit 23 centrally controls other parts of the coupon printer CP, and includes a CPU as an operating unit, ROM that nonvolatilely stores the firmware that is executed by the CPU in a computer-readable manner, RAM that temporarily stores the program executed by the CPU and data used in the program, and other peripheral circuits. The printer control unit 23 also has a related data generating unit 28 further described below.

The print engine 24 produces coupons as controlled by the printer control unit 23 by operating the inkjet head 11, a paper feed motor that drives the paper feed rollers that convey the recording medium, and a carriage drive motor that drives the carriage to make the inkjet head 11 scan in the primary scanning direction and record an image on the recording medium while monitoring output from various sensors.

The printer display unit 25 has an LCD or other type of display panel, and displays information on the display panel as controlled by the printer control unit 23. The printer input unit 29 is connected to switches disposed to the coupon printer CP, detects operation of the switches, and outputs to the printer control unit 23.

The printer-side interface 26 communicates with the coupon printer control computer 12 as controlled by the printer control unit 23 according to a specific communication protocol.

The printer storage unit 27 includes EEPROM or a hard disk drive, for example, and stores data rewritably.

The related data generating unit 28 of the printer display unit 25 is described next. The function of the related data generating unit 28 is achieved by the cooperation of hardware and software, such as by the CPU reading and running firmware.

The related data generating unit 28 appropriately rewrites the content of the daily ink consumption data 30, daily print count data 31, nozzle check results data 32, and cleaning command data 33 stored in the printer storage unit 27.

More specifically, the daily ink consumption data 30 is data indicating the total amount of ink consumed by the coupon printer CP in one day. In this embodiment ink consumption is calculated based on the number of times (number of shots) ink is ejected from the ink cartridge 13.

The store in which the coupon printer CP is used in this embodiment opens in the morning and closes at night. The related data generating unit 28 counts the number of times ink is ejected from the inkjet head 11 of the coupon printer CP (the number of shots) between opening and closing, and overwrites the content of the daily ink consumption data 30 appropriately. More specifically, the daily ink consumption data 30 is data indicating the total number of shots in one day where a day is the time from store opening to store closing each day.

The daily print count data 31 indicates the total number of coupons printed by the coupon printer CP in one day.

The related data generating unit 28 counts the number of coupons printed by the coupon printer CP from store opening to closing, and overwrites the content of the daily print count data 31 appropriately.

The nozzle check results data 32 is data indicating the results of nozzle check operations performed on a certain day. As described above, the nozzle check operation checks the nozzles of the inkjet head 11 for any ink ejection problems.

Each time a nozzle check operation is performed any day, the related data generating unit 28 gets the time the nozzle check operation was performed and the result of the nozzle check, and overwrites the content of the nozzle check results data 32 accordingly to store the correlation between nozzle check time and results in the nozzle check results data 32.

The cleaning command data 33 is data indicating what time performing a cleaning operation was commanded on any day.

When a cleaning operation command is asserted between store opening and closing, the related data generating unit 28 gets the time the command was executed and appropriately changes the content of the cleaning command data 33. Note that when a cleaning operation is triggered by a command from the user U, an ink ejection problem or something suggesting an ink ejection problem has occurred, and the cleaning operation was likely performed to solve the problem. The number of times a cleaning operation command was issued on any day can also be acquired by referencing the cleaning command data 33.

As shown in FIG. 2, the coupon printer control computer 12 has a host control unit 36 that controls other parts of the coupon printer control computer 12, a host display unit 37 that displays information on a display panel, a host input unit 38 that detects operation of the input devices and outputs to the host control unit 36, a host storage unit 39 that rewritably stores data, and a host-side communication interface 40 for communicating with the coupon printer CP and central server 18.

When a printer driver for controlling the coupon printer CP is installed to the coupon printer control computer 12 and a coupon is to be printed, the host control unit 36 generates control commands for performing the operations used to produce a coupon by reading and executing the printer driver, and outputs the control commands to the coupon printer CP.

The printer control unit 23 of the coupon printer CP then controls the print engine based on the input control commands and performs the operations related to producing a coupon.

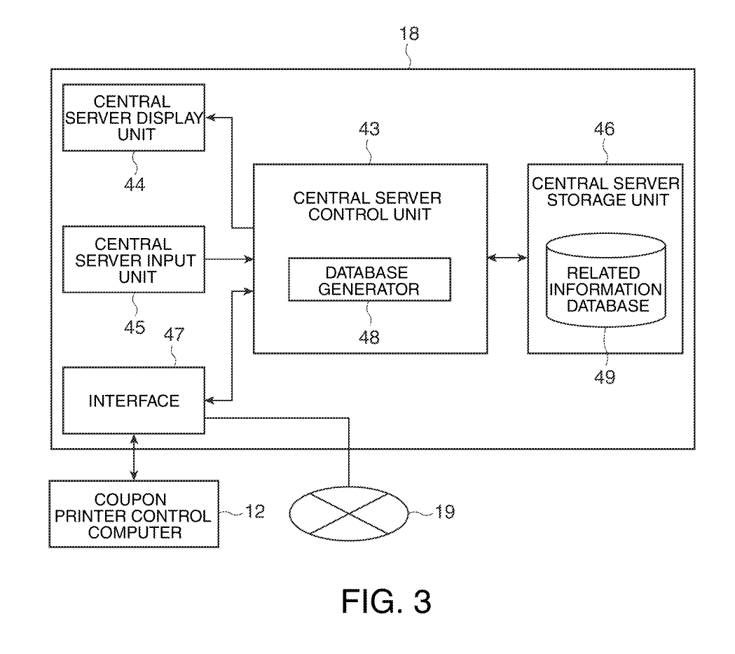

FIG. 3 is a block diagram showing the functional configuration of the central server 18.

As shown in FIG. 3, the central server 18 has a central server control unit 43 that centrally controls other parts of the central server 18, a central server display unit 44 that display information on a display panel, a central server input unit 45 that detects input device operations and outputs to the central server control unit 43, a central server storage unit 46 that rewritably stores data, and a server-side communication interface 47 for communicating with the coupon printer control computer 12.

The database generator 48 of the central server control unit 43, and the related information database 49 stored in the central server storage unit 46, are described next. The function of this database generator 48 is achieved by the cooperation of hardware and software, such as by the CPU running a program.

The database generator 48 works with the coupon printer control computer 12 and coupon printer CP at a specific time after the store closes and before the store opens again to run a database generating process and update the related information database 49 stored in the central server storage unit 46. The database generating process is thus run as a nighttime batch process after the store closes each day.

More specifically, when the specific time arrives after the store closes, the database generator 48 controls the coupon printer control computer 12 to get the daily ink consumption data 30, daily print count data 31, nozzle check results data 32, and cleaning command data 33 from each coupon printer CP connected to the coupon printer control computer 12. The database generator 48 also controls the coupon printer control computer 12 to return the store ID uniquely identifying the store, and a printer ID uniquely identifying each coupon printer CP, together with the other collected data to the database generator 48.

The daily ink consumption data 30, daily print count data 31, nozzle check results data 32, and cleaning command data 33 from each coupon printer CP in the store system 10 is thus linked to the store ID and printer ID before being sent to the database generator 48 of the central server 18.

Based on the input data, the database generator 48 generates a record for each coupon printer CP in the related information database 49.

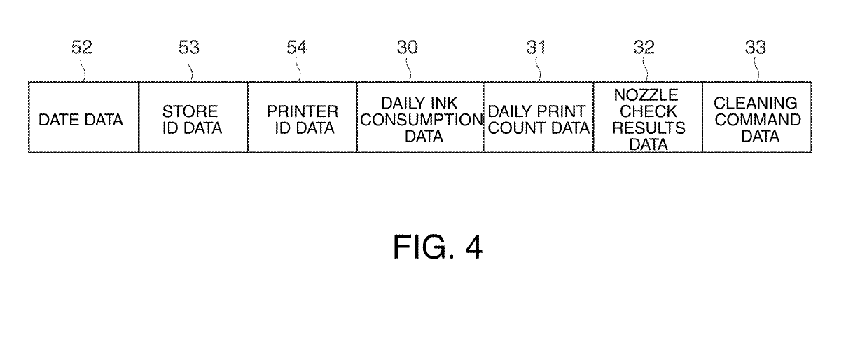

FIG. 4 shows the data structure of one record in the related information database 49.

As shown in FIG. 4, each record in the related information database 49 contains date data 52, store ID data 53, printer ID data 54, daily ink consumption data 30, daily print count data 31, nozzle check results data 32, and cleaning command data 33.

The date data 52 is data indicating the current date (the date of the day of the time span from the preceding store opening to closing (the most recent business day)).

The store ID data 53 is data indicating the above store ID, and the printer ID data 54 is data indicating the above printer ID.

As shown in FIG. 4, one record per coupon printer CP is created in the related information database 49 each time the database generating process runs, and each record contains the daily ink consumption data 30, daily print count data 31, nozzle check results data 32, and cleaning command data 33 related to the date the database generating process was run, the store ID, and the printer ID.

FIG. 5 is a block diagram showing the functional configuration of the management server 20.

As shown in FIG. 5, the management server 20 has a management server control unit 56 that centrally controls parts of the management server 20, a management server display unit 57 that displays information on a display panel, a management server input unit 58 that detects input device operations and outputs to the management server control unit 56, a management server storage unit 59 that stores data rewritably, and a management server-side communication interface 60 for communicating with the central server 18 over the network 19.

The management server 20 also has a function for outputting at least model information 21.

The operation of the management server 20 that outputs the model information 21, and the content of the model information 21, are described next by describing the related information acquisition unit 62 and model information output unit 63 of the management server control unit 56.

Note that the function of the related information acquisition unit 62 and model information output unit 63 is achieved by the cooperation of hardware and software, such as a CPU reading and running a program.

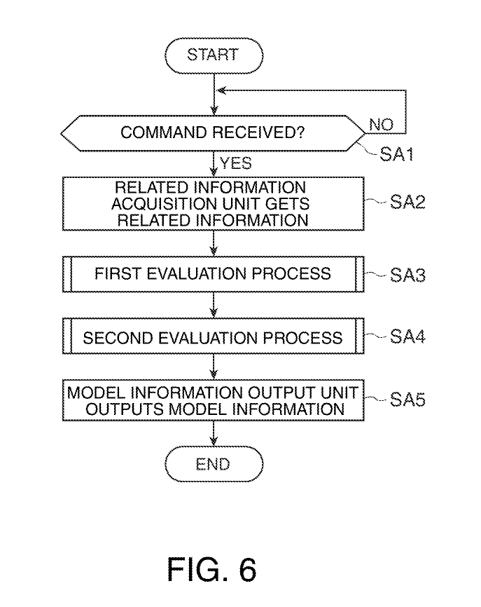

FIG. 6 is a flow chart of management server 20 operation.

The management server control unit 56 of the management server 20 monitors if a particular coupon printer CP is commanded to output the model information 21 (step SA1). The model information 21 described below is created for each coupon printer CP. The operator of the management server 20 then operates an input device connected to the management server 20 as needed after determining the printer ID of the coupon printer CP to output the model information 21, and commands the coupon printer CP to output the coupon printer CP model information 21.

When a particular coupon printer CP is commanded to output the model information 21, the related information acquisition unit 62 of the management server control unit 56 accesses the related information database 49 stored in the central server storage unit 46 of the central server 18, and retrieves a record for that one coupon printer CP using the printer ID of the coupon printer CP as a search key (step SA2). At this time the related information acquisition unit 62 uses the value from the date data 52 in each record to get the records created within a specific period of time (such as the period to the present from one week prior to the current time, or the period from one month ago to the present). As described above with reference to FIG. 4, the daily ink consumption data 30, daily print count data 31, nozzle check results data 32, and cleaning command data 33 is contained in each record, and the related information acquisition unit 62 gets this data as the related information in step SA2. The related information acquisition unit 62 thus gets a history of related information.

Note that the one coupon printer CP commanded to output the model information 21 in step SA1 is referred to as simply the coupon printer CP below.

The management server control unit 56 then runs a first evaluation process (step SA3), and then a second evaluation process (step SA4). This first evaluation process and second evaluation process are described below.

Next, the management server control unit 56 generates model information 21 (step SA5) based on the result of the first evaluation process from step SA3 and the result of the second evaluation process from step SA4. The content of this model information 21 is described below.

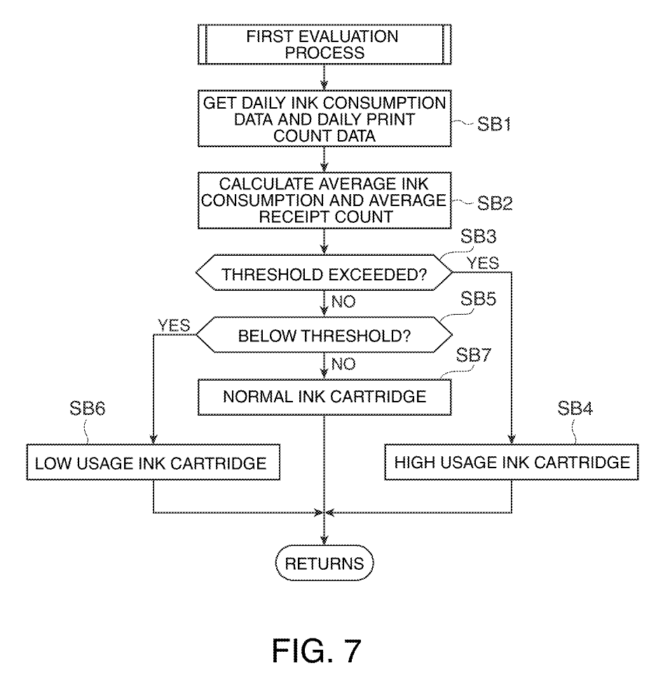

FIG. 7 is a flow chart of the operation of the management server 20 in the first evaluation process in step SA3.

In the first evaluation process, the management server control unit 56 gets the daily ink consumption data 30 and daily print count data 31 from each record acquired in step SA2 in FIG. 6 (step SB1).

Next, the management server control unit 56 calculates the average of the daily ink consumption data 30 values from each of the records (the “average ink consumption” below), and calculates the average of the daily print count data 31 values from each of the records (“average receipt count” below) (step SB2). The average ink consumption calculated in step SB2 is the average daily ink consumption during the specific period for which the records were retrieved, and the average receipt count is the average number of coupons printed daily during the specific period.

Next, the management server control unit 56 determines if the average ink consumption calculated in step SB2 exceeds threshold value T1, and determines if the average receipt count exceeds threshold value T2 (step SB3).

If the average ink consumption exceeds threshold value T1, or the average receipt count exceeds threshold value T2 (step SB3 returns Yes), the management server control unit 56 determines the ink cartridge 13 used by the coupon printer CP is a high usage ink cartridge 13a (step SB4).

A high usage ink cartridge 13a is an ink cartridge 13 that holds more ink than a regular ink cartridge 13 (a “normal ink cartridge 13b” below). Because the high usage ink cartridge 13a holds a large amount of ink, the high usage ink cartridge 13a can reduce how frequently the ink cartridge 13 is replaced when installed in a coupon printer CP that consumes ink quickly while preventing the replacement interval from becoming so long that the ink is adversely affected. The high usage ink cartridge 13a is therefore an ink cartridge 13 that is suited to use in a coupon printer CP that consumes ink at a fast pace and for which the average ink consumption exceeds threshold value T1 or the average receipt count exceeds threshold value T2.

Note that threshold value T1 and threshold value T2 are used to determine if the pace of ink consumption is great enough that installing a high usage ink cartridge 13a is preferable, and are set desirably from tests or simulations.

In addition to the average ink consumption, the average receipt count is also used as a standard for determining if a high usage ink cartridge 13a is suitable for the coupon printer CP. This is because when the number of coupons issued per day is high, the amount of ink used on one coupon is low, and the average ink consumption is low, the average ink consumption could increase significantly if the image recorded to the coupons is changed and the amount of ink used on one coupon increases. Therefore, when the average ink consumption is low and the average receipt count exceeds threshold value T2, the latent ink consumption is high. This embodiment of the invention therefore uses the average receipt count as the standard for determining if the high usage ink cartridge 13a is suited to the coupon printer CP.

If in step SB3 the average ink consumption exceeds threshold value T1 and the average receipt count exceeds threshold value T2, the management server control unit 56 determines that the average ink consumption is less than threshold T3 and the average receipt count is less than threshold T4 (step SB5).

If the average ink consumption is less than threshold T3, or the average receipt count is less than threshold T4 (step SB5 returns Yes), the management server control unit 56 determines that the ink cartridge 13 suited to the coupon printer CP is a low usage ink cartridge 13c (step SB6).

A low usage ink cartridge 13c is an ink cartridge 13 with a larger waste ink tank 16 than a normal ink cartridge 13b.

If the frequency of coupon printer CP usage is low, the amount of ink used in the cleaning operation, flushing operation, and nozzle check operation is greater than the amount of ink used to record images when compared with a coupon printer CP that is used frequently. In addition, while the time spent on operations related to image recording is necessarily low when the frequency of coupon printer CP usage is low, the time spent on the cleaning operation, flushing operation, and nozzle check operation does not decrease appreciably because these operations are performed regularly or when needed, and the amount of ink used for the cleaning operation, flushing operation, and nozzle check operation increases relative to the amount of ink stored in the ink cartridge 13.

In this case the amount of ink stored as waste ink in the waste ink tank 16 increases. Because the ink cartridge 13 used for the waste ink tank 16 is replaced when the amount of waste ink stored in the waste ink tank 16 exceeds a specific level as described above, the ink cartridge 13 must be replaced more frequently because the amount of waste ink stored in the waste ink tank 16 increases, and replacing the ink cartridge 13 may be required even though sufficient ink remains in the black ink cartridge 14 or red ink cartridge 15.

Therefore, because the capacity of the waste ink tank 16 is large, the low usage ink cartridge 13c can, when installed in a coupon printer CP with a low usage frequency, prevent the amount of waste ink stored in the waste ink tank 16 from exceeding the specific level in a short time, and can reduce the frequency of ink cartridge 13 replacement. The low usage ink cartridge 13c is therefore an ink cartridge 13 that is suited to a coupon printer CP that is used infrequently and the average ink consumption is less than threshold T3 or the average receipt count is less than threshold T4.

Note that threshold T3 and threshold T4 are used to determine if the usage frequency is below the level at which installing a low usage ink cartridge 13c is appropriate, and can be determined from tests or simulations.

If the average ink consumption exceeds threshold T3 and the average receipt count exceeds threshold T4 in step SB5, the management server control unit 56 determines if the ink cartridge 13 that is installed in the coupon printer CP is a normal ink cartridge 13b (step SB7).

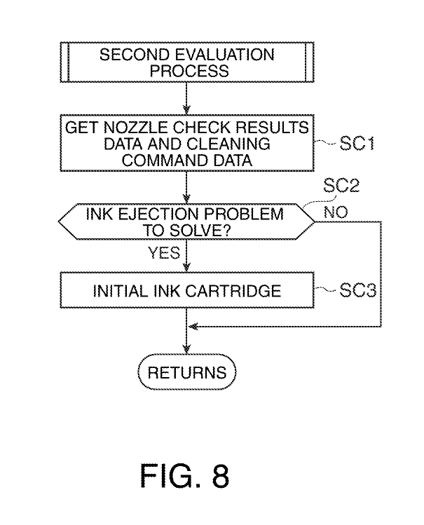

FIG. 8 is a flow chart of the operation of the management server 20 in the second decision step in step SA4 in FIG. 6.

In this second decision step the management server control unit 56 first gets the nozzle check results data 32 and the cleaning command data 33 from the records acquired in step SA2 in FIG. 6 (step SC1).

Next, the management server control unit 56 determines if there is an error related to ink ejection that requires resolving by performing a process involving ejecting ink in a cleaning operation of the coupon printer CP based on the nozzle check results data 32 and the cleaning command data 33 (step SC2).

This step SC2 is described below.

The initial ink cartridge 13d is an ink cartridge 13 that stores ink assuming that much ink will be used in the flushing operation, cleaning operation, and nozzle check operation. The user U is charged by the manufacturer M for ink cartridges 13 based on ink cartridge 13 consumption in this embodiment of the invention, but is either not charged or is charged a discounted amount for the initial ink cartridge 13d. An initial ink cartridge 13d is identified by an appropriate label affixed to the initial ink cartridge 13d, or by using a different color cartridge than other ink cartridges 13, so that an initial ink cartridge 13d is visually different from other ink cartridges 13.

As described above, if the cleaning operation is performed by command, an ink ejection problem or something suggesting an ink ejection problem has occurred, and performing the cleaning operation was likely commanded to solve the problem. Therefore, if a cleaning operation is commanded or a cleaning operation is performed repeatedly during a short period of time, there is a strong possibility that an error related to ink ejection has occurred. In step Sc2, therefore, the management server control unit 56 determines based on the content of the cleaning command data 33 if plural cleaning operations have been commanded within a short time, or if a cleaning operation has been commanded repeatedly over an extended period of time, and by performing a process involving ejecting ink when a cleaning operation is commanded in such cases, determines if conditions require solving an error related to ink ejection.

The nozzle check results data 32 is data indicating for each nozzle of the inkjet head 11 in the coupon printer CP if an ejection problem was identified based on the results of the nozzle check operation that was performed.

Whether ink ejection problems tend to occur easily can therefore be determined based on the content of the nozzle check results data 32. For example, if multiple periodic nozzle check operations indicate that an ejection problem constantly occurs with a particular nozzle, a tendency for ink ejection problems can be determined. Because some sort of problem with the ink itself is not an uncommon cause for frequently occurring ink ejection problems, the ejection problem can be effectively solved by performing a process involving ejecting ink, such as a cleaning operation.

In step SC2, therefore, the management server control unit 56 determines if there is a tendency for frequent ejection problems based on the content of the nozzle check results data 32, and if such a tendency is detected, determines that the error related to an ejection problem can be solved by performing a process involving ejecting ink.

If in step SC2 in FIG. 8 the management server control unit 56 determines that the error related to ink ejection can be solved by performing a cleaning operation or other process involving ejecting ink (step SC2 returns Yes), the management server control unit 56 determines that the initial ink cartridge 13d is the ink cartridge 13 suited to the coupon printer CP.

As described above, because the initial ink cartridge 13d is an ink cartridge 13 that is provided free or at a discounted price, there is no cost to the user U for performing the cleaning operation in the coupon printer CP using the initial ink cartridge 13d, and ejection problems can be solved while reducing the financial cost to the user. User satisfaction can therefore be improved because the user U does not feel inappropriately billed for ink, and instead appreciates good customer service.

Therefore, when an error related to an ink ejection problem can be solved by a process that involves ejecting ink, the initial ink cartridge 13d is the ink cartridge 13 suited to the coupon printer CP.

Note that because much of the ink in an initial ink cartridge 13d is used for cleaning operations, the initial ink cartridge 13d could hold more ink than a normal ink cartridge 13b, or could have a large waste ink tank 16.

In step SA5 in FIG. 6, the model information output unit 63 outputs and stores model information 21 in the management server storage unit 59 based on results from steps SB4, SB6, SB7 in FIG. 7 and step SC3 in FIG. 8. More specifically, when a particular model of ink cartridge 13 is determined to be the model of ink cartridge 13 suitable for the coupon printer CP, the model information output unit 63 outputs model information 21 containing that information. Note that when plural ink cartridges 13 are determined appropriate, such as when the high usage ink cartridge 13a is determined appropriate in step SB4 in FIG. 7 and the initial ink cartridge 13d is determined appropriate in step SC3 in FIG. 8, the model information output unit 63 includes information related to all of those ink cartridges 13 in the model information 21.

FIG. 9 describes the content of the model information 21.

In the example in FIG. 9 the model information 21 includes a store ID field 65, printer ID field 66, first recommended ink cartridge field 67, and a second recommended ink cartridge field 68.

In FIG. 9, the models of ink cartridges 13 determined to be appropriate for the coupon printer CP with a printer ID of PRT01 installed in a store with store ID of T01 are a high usage ink cartridge 13a (first recommended ink cartridge field 67=high usage ink cartridge 13a), and the initial ink cartridge 13d (second recommended ink cartridge field 68=initial ink cartridge 13d).

The model information 21 in the example in FIG. 9 is the model information 21 generated by the model information output unit 63 as a result of determining the high usage ink cartridge 13a is the ink cartridge 13 appropriate to the coupon printer CP in step SB4 in FIG. 7, and determining the initial ink cartridge 13d is the ink cartridge 13 appropriate to the coupon printer CP in step SC3 in FIG. 8.

This model information 21 is used by the manufacturer M as described below, for example.

Using a specific tool, the manufacturer M makes the content of the model information 21 knowable by displaying the content of the model information 21 on the display panel of the management server 20 or outputting a recording medium on which the content of the model information 21 is written.

The manufacturer M uses the content of the model information 21 as useful information when next supplying ink cartridges 13 or offering new services to the user U.

For any particular coupon printer CP, the invention thus enables supplying the models of ink cartridges 13 suited to the particular coupon printer CP, and improving the level of customer satisfaction for a particular user U.

As described above, a management server 20 (control device) according to this embodiment of the invention is communicatively connected to a central server 18 (information processing device) that can connect to a coupon printer CP to which an ink cartridge 13 is connected. The management server 20 has a related information acquisition unit 62 and a model information output unit 63. The related information acquisition unit 62 acquires related information, which is information related to recording using the ink cartridge 13 of the coupon printer CP, or more specifically the daily ink consumption data 30, daily print count data 31, nozzle check results data 32, and cleaning command data 33, from the central server 18. Based on this information (the related information history), the model information output unit 63 outputs model information 21 including at least information identifying the model of ink cartridge suited to use by the coupon printer CP from among the plural ink cartridges 13 available. (The management server 20 has a related information acquisition unit 62 that acquires related information, which is information related to recording using the ink cartridge 13 of the coupon printer CP, or more specifically the daily ink consumption data 30, daily print count data 31, nozzle check results data 32, and cleaning command data 33, from the central server 18; and a model information output unit 63 that, based on this information (the related information history) outputs model information 21 including at least information identifying the model of ink cartridge suited to use by the coupon printer CP from among the plural ink cartridges 13 available.)

Because the output model information 21 includes information indicating which ink cartridge 13 selected from among the group of plural ink cartridges 13 models is suited to use by the coupon printer CP based on information related to recording by the coupon printer CP using the ink cartridge 13, the ink cartridge 13 appropriate to the coupon printer CP can be determined by using this model information 21.

As a result, this model information 21 can be used by the manufacturer M to, for example, supply the user U with ink cartridges 13 suited to the coupon printer CP.

Also included in the related information in this embodiment of the invention is information (daily ink consumption data 30 and daily print count data 31) related to the type of recording operation performed in the coupon printer CP. Based on the daily ink consumption data 30 and daily print count data 31 (history of information related to the type of recording operation performed by the coupon printer CP) acquired by the related information acquisition unit 62, the model information output unit 63 outputs model information 21 containing the model of ink cartridge (high usage ink cartridge 13a or low usage ink cartridge 13c) suited to the pace of ink consumption and the pace of receipt printing (type of recording operation) by the coupon printer CP from among the plural ink cartridge models available.

Because the output model information 21 thus contains information identifying the ink cartridge 13 suited to the type of recording operation performed by the recording device, the model information 21 can be used to determine the ink cartridge 13 suited to the coupon printer CP to also reflect the type of recording operation performed by the coupon printer CP.

Furthermore, the related information in this embodiment contains daily ink consumption data 30 (information related to consumption of ink from the ink cartridge) and daily print count data 31 (information related to the frequency of recording operations by the coupon printer CP).

As a result, because information related to consumption of ink from the ink cartridge 13, and information identifying the ink cartridge 13 suited to the type of recording operation performed by the coupon printer CP based on information related to the frequency of recording operations by the coupon printer CP, are included in the model information 21, the model information 21 can be used to determine the ink cartridge 13 suited to the coupon printer CP based on the type of recording operations performed by the coupon printer CP.

Furthermore, the related information in this embodiment includes information related to ink ejection by the ink cartridge 13 (nozzle check results data 32 and cleaning command data 33), and the model information output unit 63 outputs model information 21 including at least information denoting the model of ink cartridge (initial ink cartridge 13d) corresponding to the ink ejection conditions based on data acquired by the related information acquisition unit 62 (history of information related to ejection of ink from the ink cartridge).

As a result, because information identifying which of the plural models of ink cartridges 13 is the ink cartridge 13 model corresponding to the ink ejection conditions is included in the output model information 21, this model information 21 can be used to determine the ink cartridge 13 suited to the coupon printer CP based on the actual ink ejection conditions.

The initial ink cartridge 13d in this embodiment stores ink that is used to eliminate ejection errors on the premise that the initial ink cartridge 13d is used to resolve errors related to ink ejection. Based on the history of information (nozzle check results data 32 and cleaning command data 33) related to ink ejection errors by the ink cartridge 13 that is acquired by the related information acquisition unit 62, the model information output unit 63 determines if operating conditions indicate the initial ink cartridge 13d should be used to resolve the ink ejection errors, and if these conditions are found, outputs model information 21 containing information indicating that the initial ink cartridge 13d is the model of ink cartridge 13 suited to the coupon printer CP.

As a result, the model information 21 can be used to appropriately supply initial ink cartridges 13d in operating conditions in which ink ejection problems should be solved using the initial ink cartridge 13d.

The information related to errors associated with ejecting ink from an ink cartridge that is contained in the related information in this embodiment of the invention is the nozzle check results data 32 (information indicating the results of nozzle checks of the inkjet head 11 in the coupon printer CP) and the cleaning command data 33 (information related to nozzle ejection problems).

As a result, because information identifying the model of ink cartridge 13 suited to the ink ejection conditions based on the nozzle check results data 32 and cleaning command data 33 is included in the model information 21, the model information 21 can be used to determine the ink cartridge 13 suited to the coupon printer CP reflecting the actual ink ejection conditions of the coupon printer CP.

It will be obvious to one with ordinary skill in the related art that the foregoing is one example of the invention, can be modified and adapted in many ways without departing from the scope of the accompanying claims.

For example, the recording device in the foregoing embodiment is a coupon printer CP that prints coupons, but the recording device is not limited to recording devices that print coupons. More specifically, the invention can be broadly adapted to use in recording devices that use an ink cartridge.

The central server 18 is an information processing device in the foregoing embodiment, but the function of the information processing device is not limited to a central server 18, and could be rendered in the coupon printer control computer 12 or coupon printer CP. More specifically, any device that can provide the information related to recording using an ink cartridge 13 to a control device (the management server 20 in this embodiment) can function as the information processing device.

In addition, the coupon printer control computer 12 or central server 18 could be made to function as the information processing device, and the function of the management server 20 (functions at least including the related information acquisition unit 62 and model information output unit 63) in the foregoing embodiment could be rendered by the coupon printer control computer 12 or central server 18 functioning as the information processing device.

Yet further, the related information output from the central server 18 functioning as an information processing device in the foregoing embodiment to the management server 20 used as the control device is the daily ink consumption data 30, daily print count data 31, nozzle check results data 32, and cleaning command data 33, but the related information is not limited thereto. More specifically, the related information is information related to recording using an ink cartridge 13 in a recording device, and conceptually includes all information supplied to determine the model of ink cartridge 13 suited to a coupon printer CP.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A control device that is communicatively connected to an information processing device that can connect to a recording device in which an ink cartridge is installed and which records by ejecting ink from a recording head, the control device comprising:
a related information acquisition unit that acquires related information, which is information related to recording by the recording device using the ink cartridge, from the information processing device; and
a model information output unit that, based on a history of the related information acquired by the related information acquisition unit, determines at least a model of the ink cartridge suited to use by the recording device selected from among a plurality of ink cartridge models, and outputs model information including information identifying the ink cartridge model.

2. The control device described in claim 1, wherein:
the related information includes at least information related to the type of operation related to recording in the recording device; and
the model information output unit determines the model of ink cartridge suited to the recording operation performed by the recording device selected from among plural ink cartridge models based on a history of information related to the type of operation related to recording in the recording device acquired by the related information acquisition unit, and outputs the model information including information identifying the model of ink cartridge.

3. The control device described in claim 2, wherein:
the information related to the type of operation related to recording in the recording device is information related to consumption of ink in the ink cartridge, or information related to the frequency of recording operations in the recording device.

4. The control device described in claim 1, wherein:
the related information includes at least information related to ejection of ink from the ink cartridge; and
the model information output unit determines the model of ink cartridge suited to the ink ejection conditions selected from among plural ink cartridge models based on a history of information related to ink ejection from the ink cartridge acquired by the related information acquisition unit, and outputs the model information including information identifying the model of ink cartridge.

5. The control device described in claim 4, wherein:
one model of ink cartridge stores ink that is ejected from the recording head for an application other than recording;
the information related to ink ejection from the ink cartridge includes information related to an error associated with inspecting ink ejection by the recording head; and
the model information output unit outputs the model information including information identifying the one model of ink cartridge as the ink cartridge model suited to the recording device based on a history of information related to an error associated with inspecting ink ejection by the recording head acquired by the related information acquisition unit.

6. The control device described in claim 5, wherein:
the information related to an error associated with inspecting ink ejection by the recording head includes information identifying a result of a recording head nozzle check, or information related to a nozzle ejection problem.

7. An information processing device that can connect to a recording device in which an ink cartridge is installed and which records by ejecting ink from a recording head, the information processing device comprising:
a related information acquisition unit that acquires related information, which is information related to recording by the recording device using the ink cartridge, from the recording device; and
a model information output unit that, based on a history of the related information acquired by the related information acquisition unit, determines at least a model of the ink cartridge suited to use by the recording device selected from among a plurality of ink cartridge models, and outputs model information including information identifying the ink cartridge model.

8. A control method for a control device that is communicatively connected to an information processing device that can connect to a recording device in which an ink cartridge is installed and which records by ejecting ink from a recording head, the control method comprising steps of:
acquiring related information, which is information related to recording by the recording device using the ink cartridge, from the information processing device; and
determining at least a model of the ink cartridge suited to use by the recording device selected from among a plurality of ink cartridge models based on a history of acquired related information; and
outputting model information, which is information including information identifying the ink cartridge model.

9. The control method for a control device described in claim 8, wherein:
the related information includes at least information related to the type of operation related to recording in the recording device; and
the control method further comprises steps of
determining the model of ink cartridge suited to the recording operation performed by the recording device selected from among plural ink cartridge models based on a history of information related to the type of operation related to recording in the recording device, and
outputting the model information including information identifying the model of ink cartridge.

10. The control method for a control device described in claim 9, wherein:
the information related to the type of operation related to recording in the recording device is information related to consumption of ink in the ink cartridge, or information related to the frequency of recording operations in the recording device.

11. The control method for a control device described in claim 8, wherein:
the related information includes at least information related to ejection of ink from the ink cartridge; and
the control method further comprises steps of determining the model of ink cartridge suited to the ink ejection conditions
selected from among plural ink cartridge models based on a history of information related to ink ejection from the ink cartridge, and
outputting the model information including information identifying the model of ink cartridge.

12. The control method for a control device described in claim 11, wherein:
the information related to ink ejection from the ink cartridge includes information related to an error associated with inspecting ink ejection by the recording head; and
the control method further comprises a step of
outputting the model information including information identifying the one model of ink cartridge as the ink cartridge model suited to the recording device based on a history of information related to an error associated with inspecting ink ejection by the recording head.

13. The control method for a control device described in claim 12, wherein:
the information related to an error associated with inspecting ink ejection by the recording head includes information identifying a result of a recording head nozzle check, or information related to a nozzle ejection problem.
